(19) United States
(12) Patent Application Publication
(10) Pub. No.: US 2026/0352681 A1
(43) Pub. Date: Nov. 5, 2026

(54) SYSTEMS AND METHODS FOR DYNAMIC PRIVILEGE ACCESS AGGREGATION AND ANOMALY DETECTION IN A DISTRIBUTED NETWORK SYSTEM

(71) Applicant: BANK OF AMERICA CORPORATION, Charlotte, NC (US)

(72) Inventors: Vishal Wadhwa, Hyderabad (IN); Aditya Anil Kulkarni, Thane (IN); Divya Sreenivasan, Chennai (IN)

(73) Assignee: BANK OF AMERICA CORPORATION, Charlotte, NC (US)

(21) Appl. No.: 19/195,052

(22) Filed: Apr. 30, 2025

(51) Int. Cl. H04L 9/40; H04L 41/16

(52) U.S. Cl. CPC H04L 63/1425; H04L 41/16; H04L 63/102

(57) ABSTRACT

Systems, methods, and computer program products are provided herein for dynamic privilege access aggregation and anomaly detection in a distributed network system. An example method includes receiving operation data from a plurality of disparate privilege access systems associated with a plurality of users and include a first privilege access system and a second privilege access system and training a first machine learning (ML) model on the operation data of the plurality of disparate privilege access systems to generate a first trained ML model. The method further includes receiving interaction data associated with a first user for evaluation, deploying the first trained ML model on the interaction data of the first user, determining an anomaly for the interaction data of the first user based on the output of the deployed first trained ML on the interaction data, and generating an anomaly output comprising the determined anomaly.

### TECHNOLOGICAL FIELD

Example embodiments of the present disclosure relate generally to distributed networks and, more particularly, to systems and methods for dynamic privilege access aggregation and anomaly detection in these network implementations.

### BACKGROUND

Electronic networks formed of distributed components may host, permission access to, or otherwise support interactions with a variety of applications in order to perform the various operations associated with the network. Various disparate or otherwise isolated systems may be associated with the permissioning of access for the users in such a network. Applicant has identified a number of deficiencies and problems associated with conventional systems and associated methods. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided herein for dynamic privilege access aggregation and anomaly detection in a distributed network system. In one embodiment, a system for dynamic privilege access aggregation and anomaly detection in a distributed network system is provided. The example system may include at least one non-transitory storage device and at least one processor coupled to the at least one non-transitory storage device. The at least one processor may be configured to receive operation data from a plurality of disparate privilege access systems. The plurality of disparate privilege access systems may be associated with a plurality of users and include at least a first privilege access system and a second privilege access system. The processor may train a first machine learning (ML) model on the operation data of the plurality of disparate privilege access systems to generate a first trained ML model.

The processor may further receive interaction data associated with a first user for evaluation, deploy the first trained ML model on the interaction data of the first user, and determine an anomaly for the interaction data of the first user based on the output of the deployed first trained ML on the interaction data. The processor may further generate an anomaly output comprising the determined anomaly for the interaction data of the first user.

In some embodiments, the processor may be further configured to supply the anomaly output to the first trained ML model and update the first trained ML based on the anomaly output.

In some embodiments, the first user may be absent from the plurality of users associated with the plurality of disparate privilege access systems.

In other embodiments, the plurality of users associated with the plurality of disparate privilege access systems may include the first user.

In some embodiments, the processor may be further configured to supply the anomaly output to the first privilege access system in a first data configuration and supply the anomaly output to the second privilege access system in a second data configuration different from the first data configuration.

In some embodiments, the anomaly output may be configured to preclude access of the first user to at least one of the disparate privilege access systems.

In some embodiments, the first privilege access system may be isolated from the second privilege access system.

In some embodiments, in training the first ML model, the processor may be further configured to perform one or more data preparation operations on the operation data from the plurality of disparate privilege access systems, generate a plurality of similarly metrics for the operation data, assemble the operation data based on the generated similarly metrics, and perform interrogative analysis on the assembled operation data to model expected activity for the plurality of users.

In some embodiments, the processor may be further configured to receive a plurality of interaction data entries associated with the first user and train a second ML model on the plurality of interaction data entries for the first user to generate a second trained ML model.

In some further embodiments, the processor may be configured to deploy the second trained ML model on the interaction data of the first user received for evaluation and modify the anomaly output based on the output of the deployed second trained ML.

In another embodiment, a dynamic privilege access aggregation and anomaly detection in a distributed network system is provided. The computer program product may include a non-transitory computer-readable medium including code that, when executed, causes an apparatus to: receive operation data from a plurality of disparate privilege access systems, wherein the plurality of disparate privilege access systems are associated with a plurality of users and include at least a first privilege access system and a second privilege access system; train a first machine learning (ML) model on the operation data of the plurality of disparate privilege access systems to generate a first trained ML model; receive interaction data associated with a first user for evaluation; deploy the first trained ML model on the interaction data of the first user; determine an anomaly for the interaction data of the first user based on the output of the deployed first trained ML on the interaction data; and generate an anomaly output comprising the determined anomaly for the interaction data of the first user.

In another embodiment, a method for dynamic privilege access aggregation and anomaly detection in a distributed network system is provided. The method may include receiving operation data from a plurality of disparate privilege access systems, wherein the plurality of disparate privilege access systems are associated with a plurality of users and include at least a first privilege access system and a second privilege access system; training a first machine learning (ML) model on the operation data of the plurality of disparate privilege access systems to generate a first trained ML model; receiving interaction data associated with a first user for evaluation; deploying the first trained ML model on the interaction data of the first user; determining an anomaly for the interaction data of the first user based on the output of the deployed first trained ML on the interaction data; and generating an anomaly output comprising the determined anomaly for the interaction data of the first user.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below. The features, functions, and advantages that are described herein may be achieved independently in various embodiments of the present disclosure or may be combined with yet other embodiments.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1D illustrate technical components of an exemplary distributed computing environment for dynamic privilege access aggregation and anomaly detection in a distributed network system in accordance with one or more embodiments of the present disclosure;

FIG. 2 illustrates an example method for dynamic privilege access aggregation and anomaly detection in accordance with one or more embodiments of the present disclosure;

FIG. 3 illustrates an example method for anomaly output operations in accordance with one or more embodiments of the present disclosure;

FIG. 4 illustrates an example method for ML model training in accordance with one or more embodiments of the present disclosure; and

FIG. 5 illustrates an example method for multi-modal post-validation operations in accordance with one or more embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with or who otherwise interacts with an entity. As such, in some embodiments, the user may be an individual having past relationships, current relationships, and/or potential future relationships with an entity. In some embodiments, the user may be an employee (e.g., an associate, a project manager, an IT specialist, a manager, an administrator, an internal operations analyst, or the like) of the entity or enterprises affiliated with the entity. In some embodiments, the user may be a customer (e.g., individual, business, etc.) that transacts with the entity or enterprises associated with the entity. In some embodiments, the “user(s)” described herein may refer to a user, system, device, etc. associated with a third party service provider.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users. The present disclosure contemplates that the arrangement, presentation, organization, etc. of the user interfaces described herein may vary based upon the intended application of the system.

As used herein, an “engine” or “module” may refer to core elements of an application, or part of an application that serves as a foundation for a larger piece of software and drives the functionality of the software. In some embodiments, an engine or module may be self-contained, but externally-controllable code that encapsulates powerful logic designed to perform or execute a specific type of function. In one aspect, an engine or module may be underlying source code that establishes file hierarchy, input and output methods, and how a specific part of an application interacts or communicates with other software and/or hardware. The specific components of an engine or module may vary based on the needs of the specific application as part of the larger piece of software. In some embodiments, an engine or module may be configured to retrieve resources created in other applications, which may then be ported into the engine for use during specific operational aspects of the engine. An engine or module may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” “communicably coupled” and/or the like as used herein, means that the components may be formed integrally with each other, or may be formed separately and coupled together. Furthermore, the components may be formed directly to each other, or to each other with one or more components located between the components that are operatively coupled together. Furthermore, the components may be detachable from each other, or they may permanently coupled together. Furthermore, operatively coupled components may mean that the components retain at least some freedom of movement in one or more directions or may be rotated about an axis (e.g., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer or transmission of data between devices, a system and an application, an accessing of stored data by one or more nodes of a computing cluster, a transmission of a requested task, or the like. As described hereinafter, an “interaction” between the system and one or more applications may be permissioned in that the ability for the system (e.g., one or more devices, subsystems, modules, etc.) to access a particular application may be controlled by permissions issued by this application. In some embodiments as described herein, an interaction may refer to one or more actions by a user to access particular features, applications, functionalities, etc. that may be permissioned or to which the access is otherwise restricted. By way of a non-limiting example, an interaction as described herein may refer to one or more actions by a first user to complete an authentication process for accessing a particular application, such as associated with one or more disparate privilege access systems. Although described herein with reference to an example authentication based interaction, the present disclosure contemplates that any transmission of data between a user and the systems described herein may be collectively referred to as an interaction. Furthermore, the ML models described herein may, in some embodiments, be trained on a plurality of interactions by a plurality of user associated with the disparate privilege access systems described herein (e.g., the example first trained ML model) and/or on a plurality of interactions by a specific user (e.g., the first user) to generate a user-specific, trained ML model (e.g., the example second trained ML model).

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a criterion, including that a threshold has been met, passed, exceeded, etc.

As described above, electronic networks formed of distributed components may host, permission access to, or otherwise support interactions with a variety of applications in order to perform the various operations associated with the network. One or more users may interact with the network (e.g., applications, devices, systems, etc. of the network), and various privilege access systems may operate within the network to facilitate the permissioning of these interactions. For example, a network may include a privilege access management service, a secrets management service, a privilege escalation and delegation service, and/or a privileged session management service, among others. Each of these disparate privilege access systems, however, may be associated with distinct configurations, formats, security levels, parameters, and/or other attributes, such that the data generated by these systems during operation remains isolated on the respective system.

In order to solve the issues associated with these systems, embodiments of the present disclosure provide systems and methods for dynamic privilege access aggregation and anomaly detection in a distributed network system. For example, the embodiments described herein may receive operation data from a plurality of disparate privilege access systems associated with a plurality of users. The embodiments herein may train a first machine learning (ML) model on the operation data of the plurality of disparate privilege access systems to generate a first trained ML model while maintaining isolation of the respective operation data for each respective privilege access system. The systems of the present disclosure further receive interaction data associated with a first user for evaluation, deploy the first trained ML model on the interaction data of the first user, and determine an anomaly for the interaction data of the first user based on the output of the deployed first trained ML on the interaction data. This determined anomaly, via the generation of an anomaly output, may be used to iteratively update the first trained ML model, preclude or otherwise modify access for the first user to one or more systems of the network, and/or supplied to one or more of the disparate privilege access management systems in system-specific formats to improve operations of these disparate systems. In doing so, the embodiments of the present disclosure provide new mechanisms for facilitating access management in distributed network systems while maintaining isolation of disparate privilege access systems that were historically unavailable.

### Example System and Circuitry Components

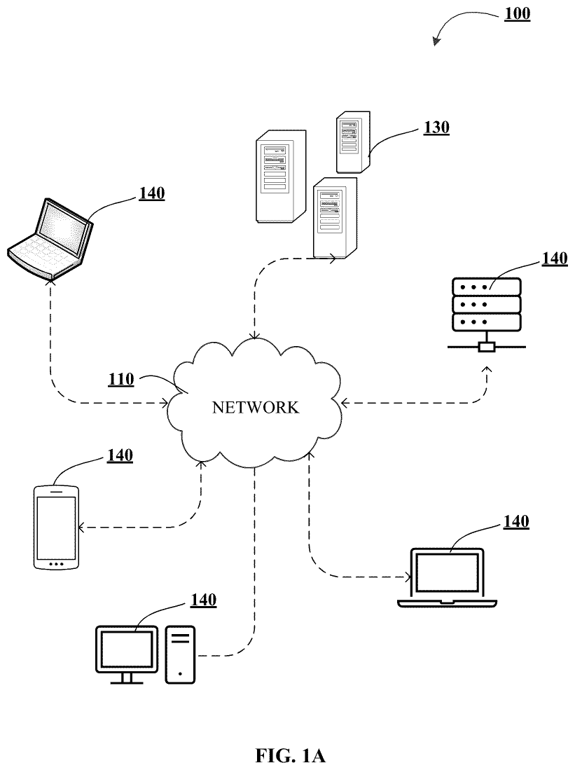

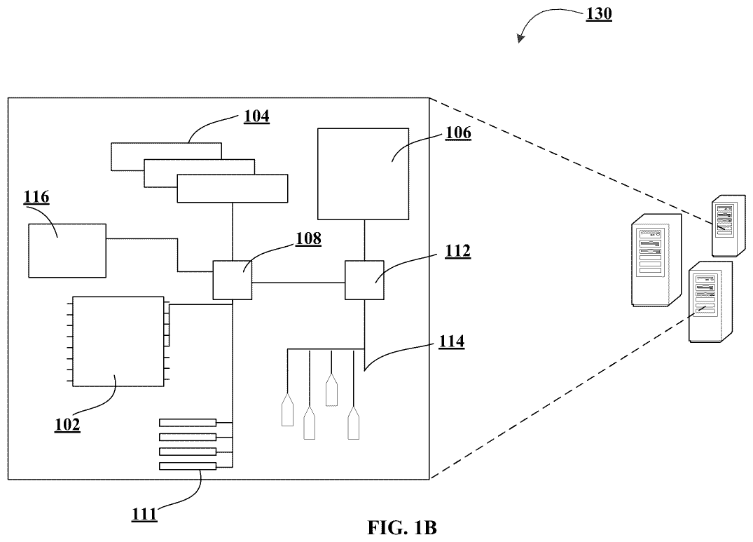

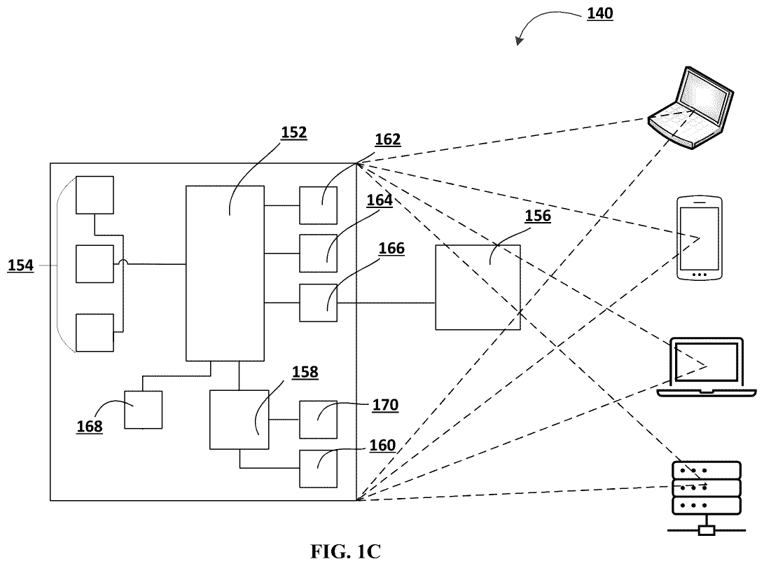

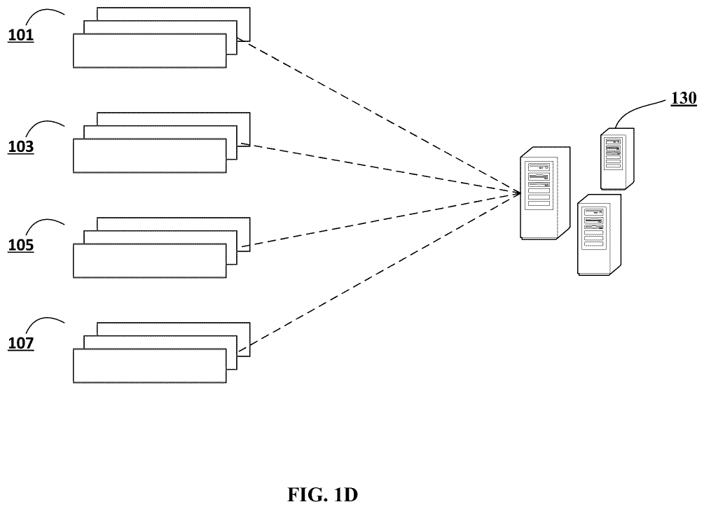

FIGS. 1A-1D illustrate technical components of an exemplary distributed computing environment for dynamic privilege access aggregation and anomaly detection 100, in accordance with one or more embodiments of the present disclosure. As shown in FIG. 1A, the distributed computing environment 100 or distributed network 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, the same or similar to system 130, with each system providing portions of the necessary operations (e.g., as a server bank, a group of blade servers, or a multi-processor system).

In some embodiments, the system 130 and the end-point device(s) 140 may define a client-server relationship in which the end-point device(s) 140 are remote devices that request and receive service from a centralized server (e.g., the system 130). In some other embodiments, the system 130 and the end-point device(s) 140 may have a peer-to-peer relationship in which the system 130 and the end-point device(s) 140 have the same abilities to use the resources available on the network 110. As opposed to relying upon a central server (e.g., system 130) that acts as the shared drive, each device that is connected to the network 110 acts as the server for the files stored thereon.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 (e.g., data entities) may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., an automated teller machine (ATM)), and/or edge devices such as routers, routing switches, integrated access devices (IAD), and/or the like.

The network 110 may be a distributed network that is spread over different networks. This provides a single data communication network that may be managed jointly or separately by each network. In addition to shared communication within the network, the distributed network may also support distributed processing. The network 110 may be a form of digital communication network, such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the embodiments of the present disclosure. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with one or more embodiments of the present disclosure. As shown in FIG. 1B, the system 130 may include a processor 102, memory 104, input/output (I/O) device 116, and/or a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. In some embodiments, the subsystems may refer to components that form respective disparate privilege access systems that are, for example, isolated from one another in operation.

The processor 102 may process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 may be capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and/or to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other. As described herein, in some embodiments, the system 130 may operate as the centralized server configured to perform the dynamic privilege access aggregation and anomaly detection operations described herein.

FIG. 1C illustrates an exemplary component-level structure of the end-point device(s) 140 (e.g., data entities described herein), in accordance with one or more embodiments of the present disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a Microdrive or other device, to provide additional storage. Each of the components 152, 154, 158, and 160, are interconnected using various buses, and several of the components may be mounted on a common motherboard or in other manners as appropriate. As described above, the end-point devices 140 described herein may be example data entities that form the distributed network. As such, the system 130 may be communicably coupled with the end-point devices 140 so as to receive data transmissions from these devices that may, for example, be used for dynamic privilege access aggregation and anomaly detection.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user (e.g., an actionable notification or the like). The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 (e.g., data entities) to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker. As described herein, the authentication and privilege access operations for disparate privilege access systems associated with the system 130 may vary and may further be isolated from one another.

The end-point device(s) 140 (e.g., data entities) may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 (e.g., data entities) may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130. Various implementations of the distributed computing environment 100, including the system 130 and end-point device(s) 140 (e.g., data entities), and techniques described here may be realized in digital electronic circuitry, integrated circuitry, specially designed ASICs (application specific integrated circuits), computer hardware, firmware, software, and/or combinations thereof.

FIG. 1D illustrates an example configuration of the system 130 and various disparate privilege access systems 101, 103, 105, 107 that may be associated with the system 130. As described above, the network 100 and/or system 130 may include various privilege access systems 101-107 that operate to facilitate the permissioning of user interactions. As shown, for example, the system 130 may be communicably coupled with a first privilege access system 101, a second privilege access system 103, a third privilege access system 105, and/or a fourth privilege access system 107. In some embodiments, each of the respective, disparate privilege access system 101-107 may be formed as a collection of applications, software, hardware, etc. that are associated with the system 130. By way of a nonlimiting example, in some embodiments, the system 130 may operate as a centralized server that includes a plurality of applications that operate as the plurality of disparate privilege access systems 101-107. In other embodiments, one or more of the plurality of disparate privilege access systems 101-107 may be located separately from the system 130 and communicably coupled with the system 130, such as via the network 110. By way of a nonlimiting example, in some embodiments, one or more end-point devices 140 may include one or more of the disparate privilege access systems 101-107, and data may be transmitted between the example end-point device 140 and the system 130.

As described herein, each of the plurality of disparate privilege access systems 101-107 may be associated with different operations, tasks, users, systems, etc. By way of example, the first privilege access system 101 may be associated with a privilege access management service. As such, the first privilege access system 101 may be, for example, configured to securely retrieve interactive account credentials, such as for users associated with the system 130. As such, the first privilege access system 101 may be associated with a first security level, first data configuration, first parameters, first attributes, and/or the like that are particular or specific to the first privilege access system 101. Furthermore, the first privilege access system 101 may store, access, manipulate, etc. data (e.g., operation data associated with the privilege access system 101) in a first format that is particular or otherwise specific to the privilege access system 101. In order to maintain integrity, security, etc. of the data for the first privilege access system 101, the first privilege access system 101 may be is isolated from the other privilege access systems 103, 105, 107.

By way of continued example, the second privilege access system 103 may be associated with a secrets management service. As such, the second privilege access system 103 may be, for example, configured to securely retrieve service account credentials, such as for third-party devices (e.g., end-point devices 140) associated with the system 130. As such, the second privilege access system 103 may be associated with a second security level, second data configuration, second parameters, second attributes, and/or the like that are particular or specific to the second privilege access system 103. Furthermore, the second privilege access system 103 may store, access, manipulate, etc. data (e.g., operation data associated with the privilege access system 103) in a second format that is particular or otherwise specific to the second privilege access system 103. In order to maintain integrity, security, etc. of the data for the second privilege access system 103, the second privilege access system 103 may be is isolated from the other privilege access systems 101, 105, 107.

By way of continued example, the third privilege access system 105 may be associated with a privilege escalation and delegation service. As such, the third privilege access system 105 may be, for example, configured to securely provide role elevation, such as for users associated with the system 130. As such, the third privilege access system 105 may be associated with a third security level, third data configuration, third parameters, third attributes, and/or the like that are particular or specific to the third privilege access system 105. Furthermore, the third privilege access system 105 may store, access, manipulate, etc. data (e.g., operation data associated with the privilege access system 105) in a third format that is particular or otherwise specific to the third privilege access system 105. In order to maintain integrity, security, etc. of the data for the third privilege access system 105, the third privilege access system 105 may be is isolated from the other privilege access systems 101, 103, 107.

By way of continued example, the fourth privilege access system 107 may be associated with a privilege escalation and delegation service. As such, the fourth privilege access system 107 may be, for example, configured to securely provide role elevation, such as for users associated with the system 130. As such, the fourth privilege access system 107 may be associated with a fourth security level, fourth data configuration, fourth parameters, fourth attributes, and/or the like that are particular or specific to the fourth privilege access system 107. Furthermore, the fourth privilege access system 107 may store, access, manipulate, etc. data (e.g., operation data associated with the privilege access system 107) in a fourth format that is particular or otherwise specific to the fourth privilege access system 107. In order to maintain integrity, security, etc. of the data for the fourth privilege access system 107, the fourth privilege access system 107 may be is isolated from the other privilege access systems 101, 103, 105.

Although the plurality of disparate privilege access systems are illustrated in FIG. 1D with four (4) privilege access systems 101, 103, 105, 107, the present disclosure contemplates that the network 100 and/or system 130 may be associated with or otherwise communicably coupled to any number of disparate privilege access systems and/or subsystems forming the same. Furthermore, although described herein with reference to privilege access systems 101-107 whose operations are associated with a privilege access management service, a secrets management service, a privilege escalation and delegation service, and/or a privileged session management service, the present disclosure contemplates that the privilege access systems 101-107 of the present disclosure may be association with the performance of any operation based on the intended application of the system 130.

### Example Methods for Dynamic Privilege Access Aggregation and Anomaly Detection

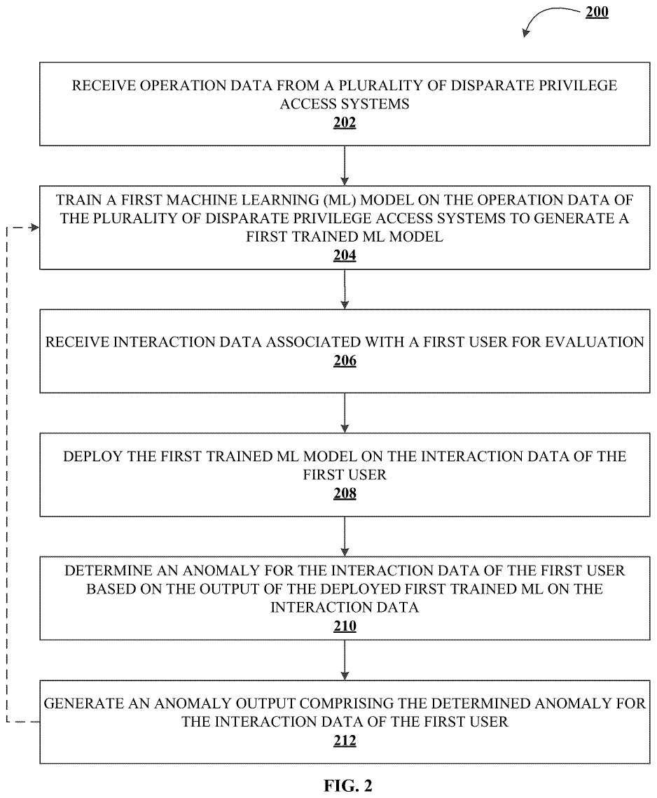

FIG. 2 illustrates a flowchart containing a series of operations for dynamic privilege access aggregation and anomaly detection in a distributed network system (e.g., method 200). The operations illustrated in FIG. 2 may, for example, be performed by, with the assistance of, and/or under the control of an apparatus (e.g., system 130, end-point devices 140 etc.), as described above. In this regard, performance of the operations may invoke one or more of the components described above with reference to FIGS. 1A-1D (e.g., processor 102, processor 152, etc.).

As shown in operation 202, the system 130 may be configured to receive operation data from a plurality of disparate privilege access systems 101-107. As described above, the system 130 may operate as a centralized server that is communicably coupled with a plurality of disparate privilege access systems 101-107, such as those illustrated in FIG. 1D, to perform the dynamic privilege access aggregation and anomaly detection operations described herein. The plurality of disparate privilege access systems 101-107 may be associated with a plurality of users and comprise at least a first privilege access system 101 and a second privilege access system 103. As described above, the present disclosure contemplates that any number of privilege access systems may be associated with the system 130 without limitation. Furthermore, the plurality of disparate privilege access systems 101-107 may associated with a plurality of users, such as the users that interact with the system 130 (e.g., the applications, services, etc. associated with the system 130). In some embodiments, the plurality of privilege access systems 101-107 may periodically transmit operation data to the system 130. In other embodiments, the system 130 may periodically query the plurality of privilege access systems 101-107 to receive the operation data at operation 202.

As described above, an interaction may refer to a transfer or transmission of data between devices, a system and an application, an accessing of stored data by one or more nodes of a computing cluster, a transmission of a requested task, or the like. An interaction may refer to one or more actions by a user to access particular features, applications, functionalities, etc. that may be permissioned or to which the access is otherwise restricted. By way of a non-limiting example, an interaction as described herein may refer to one or more actions by a first user to complete an authentication process for accessing a particular application, such as associated with one or more disparate privilege access systems. The operation data received at operation 202 that is from the plurality of disparate privilege access systems 101-107 may refer to any data that is generated by these disparate privilege access systems 101-107, such as data that is generated in response to interactions (e.g., interaction data) by the users of the system 130 interacting with the disparate privilege access systems 101-107.

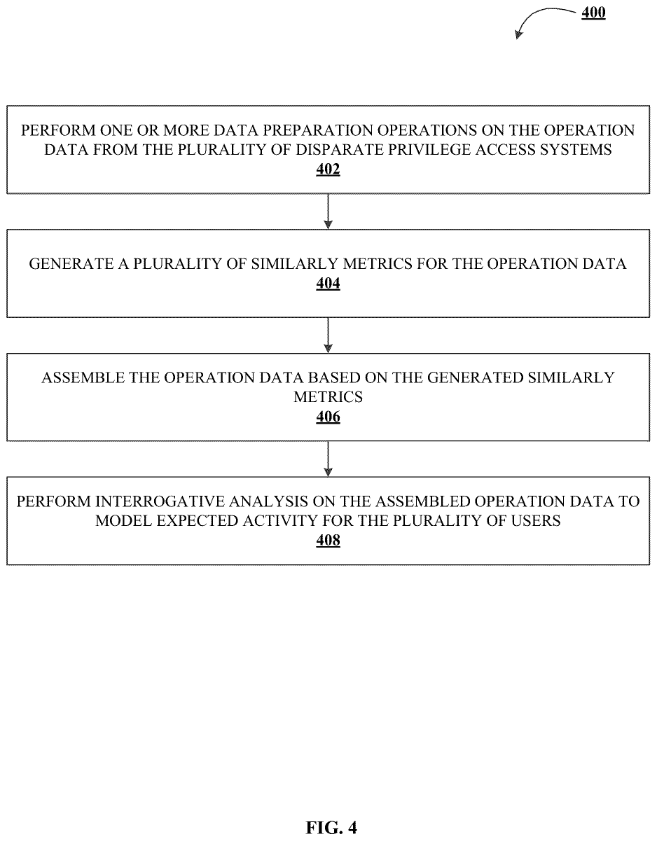

Thereafter, as shown in operation 204, the system 130 may be configured to train a first machine learning (ML) model on the operation data of the plurality of disparate privilege access systems to generate a first trained ML model. As described herein with reference to FIG. 4, the first trained ML model may refer to a model that is trained to determine what the normal or expected action, status, response, etc. for a user is given a defined set of characteristics and/or a prediction of the normal or expect action, status, response, etc. for a user interaction. In some embodiments, the first trained ML model is trained on operation data from the plurality of disparate privilege access systems that includes a plurality of users including the first user (e.g., the user's whose interaction is evaluated hereafter), such that the plurality of users associated with the plurality of disparate privilege access systems comprise the first user. In other embodiments, the first trained ML model is trained on operation data from the plurality of disparate privilege access systems that includes a plurality of users without the first user (e.g., the user's whose interaction is evaluated hereafter), such that the first user is absent from the plurality of users associated with the plurality of disparate privilege access systems. In such an embodiment, the first trained ML model may be agnostic with respect to the interactions of the first user.

The first trained ML model may refer to a mathematical model generated by machine learning algorithms based on training data (e.g., operation data from the plurality of disparate privilege access systems) to make predictions or decisions without being explicitly programmed to do so. The first trained ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The first trained ML model or algorithm may also refer to programs that are configured to self-adjust and perform better as they are exposed to more data. To this end, the first trained ML model or algorithm is also capable of adjusting its own parameters, based on previous performance in making prediction about a dataset, such as interaction data for a user.

The first ML algorithms contemplated, described, and/or used herein (e.g., the trained ML model) may include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The first ML model may be trained using repeated execution cycles of experimentation, testing, and tuning to modify the performance of the ML algorithm and refine the results in preparation for deployment of those results for consumption or decision making. The first ML model may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data.

Thereafter, as shown in operation 206, the system 130 may be configured to receive interaction data associated with a first user for evaluation. As described above, the system 130 may be associated with a plurality of users that interact with the various applications, services, etc. provided by the system 130, the subsystems of the system 130, the disparate privilege access systems 101-107, and/or the like. By way of example, a first user (e.g., the example user with interactions for evaluation) may attempt to access a particular application associated with the system 130, and the access to this particular application may be permissioned as described herein. As such, the interaction data (e.g., data entries associated with the interaction) received at operation 206 may be associated with any interaction by the first user with the systems described herein, such as a request to access an application associated with the system 130. Although described herein with interaction data associated with a discrete interaction by the first user, the present disclosure contemplates that the interaction data received at operation 206 may include a collection of data entries associated with any number of interactions of the first user for evaluation.

Thereafter, as shown in operations 208 and 210, the system 130 may be configured to deploy the first trained ML model on the interaction data of the first user and determine an anomaly for the interaction data of the first user based on the output of the deployed first trained ML on the interaction data, respectively. As described herein, the first trained ML model may be trained on operation data of the plurality of privilege access systems 101-107 in order to determine precited or otherwise usual interactions by the plurality of users that interact with these systems 101-107. As such, the first trained ML model may be deployed on the interaction data of the first user received at operation 206 in order to determine if the particular interaction data is similar to the predicted or otherwise usual interactions with the system 101-107. As described hereinafter with reference to FIG. 4, the first trained ML model may use similarity metrics and/or clustering in order to assign weighted probability, scores, metrics, etc. to particular interaction data based on the collection of operation data from the plurality of privilege access systems on which the first ML is trained. In an instance in which the interaction is appreciably different from the predicted outcome, action, etc. of the first trained ML model, the system 130 may determine an anomaly for the interaction data for the first user.

By way of example, the interaction data received at operation 206 may be associated with an action by the first user to access an application of the system 130 that is restricted. The first trained ML model may be trained on operation data from the plurality of privilege access systems that include prior attempts by users (e.g., including the first user or otherwise) to access the same application as the first user and/or any other application of the system 130. As such, the first trained ML model may be configured to analyze the interaction data of the first user to determine if the interaction data is indicative of actions, conditions, etc. of the first user that were predicted or otherwise expected by the first trained ML model. In an instance in which the interaction data received at operation 206 is appreciably different from the prediction or expected interaction data of the first ML model (e.g., indicated by a similarity metric, score, etc.) the system 130 may determine that the anomaly for the interaction data of the first user. As would be evident to one of ordinary skill in the art in light of the present disclosure, the first trained ML model may be iteratively trained on operation data that is received from the plurality of privilege access systems.

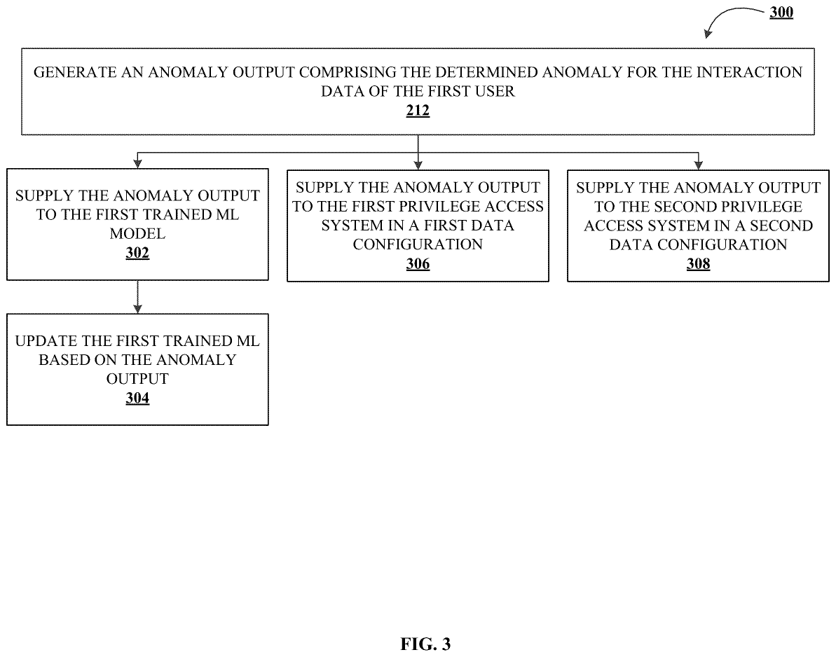

In some embodiments, as shown in operation 212, the system 130 may be configured to generate an anomaly output comprising the determined anomaly for the interaction data of the first user. As described hereafter with reference to FIG. 3, the anomaly output may, in some embodiments, refer to an output that is supplied to the ML models described herein in order to further improve the training of these ML models (e.g., an iterative update). Additionally or alternatively, in some embodiments, the anomaly output may include a notification (e.g., to a user, to a system administrator, etc.) that indicates the determination of an anomaly. Additionally or alternatively, in some embodiments, the anomaly output is configured to preclude access of the first user to at least one of the disparate privilege access systems 101-107. By way of continued example, the anomaly output may preclude the first user from accessing the intended application of the system 130.

FIG. 3 illustrates a flowchart containing a series of anomaly output operations (e.g., method 300). The operations illustrated in FIG. 3 may, for example, be performed by, with the assistance of, and/or under the control of an apparatus (e.g., system 130, end-point devices 140, etc.), as described above. In this regard, performance of the operations may invoke one or more of the components described above with reference to FIGS. 1A-1D (e.g., processor 102, processor 152, etc.).

As shown in operations 302 and 304, the system 130 may be configured to supply the anomaly output to the first trained ML model and update the first trained ML based on the anomaly output, respectively. As described herein, the training of the first ML model (e.g., trained on operation data from the plurality of privilege access systems) may be iteratively performed in order to improve the operations, deployment, determinations, etc. of the first trained ML model. As such, in some embodiments, the anomaly output that comprises the determined anomaly for the interaction data of the first user may be iteratively supplied to the first trained ML model and used to update the trained first ML model to improve subsequent performance of the first trained ML model.

Additionally or alternatively, as shown in operations 308 and 310, the system 130 may be configured to supply the anomaly output to the first privilege access system in a first data configuration and supply the anomaly output to the second privilege access system in a second data configuration different from the first data configuration, respectively. As described above, the first privilege access system 101 may be, for example, configured to securely retrieve interactive account credentials, such as for users associated with the system 130. As such, the first privilege access system 101 may be associated with a first security level, first data configuration, first parameters, first attributes, and/or the like that are particular or specific to the first privilege access system 101. Furthermore, the first privilege access system 101 may store, access, manipulate, etc. data (e.g., operation data associated with the privilege access system 101) in a first format that is particular or otherwise specific to the privilege access system 101. In order to maintain integrity, security, etc. of the data for the first privilege access system 101, the first privilege access system 101 may be is isolated from the other privilege access systems 103, 105, 107. As such, the anomaly output that is supplied to the first privilege access system may be in a first configuration that is compatible with the first privilege access system (e.g., a configuration that may be incompatible for other privilege access systems).

As above, the second privilege access system 103 may be, for example, configured to securely retrieve service account credentials, such as for third-party devices (e.g., end-point devices 140) associated with the system 130. As such, the second privilege access system 103 may be associated with a second security level, second data configuration, second parameters, second attributes, and/or the like that are particular or specific to the second privilege access system 103. Furthermore, the second privilege access system 103 may store, access, manipulate, etc. data (e.g., operation data associated with the privilege access system 103) in a second format that is particular or otherwise specific to the second privilege access system 103. In order to maintain integrity, security, etc. of the data for the second privilege access system 103, the second privilege access system 103 may be is isolated from the other privilege access systems 101, 105, 107. As such, the anomaly output that is supplied to the second privilege access system may be in a second configuration that is compatible with the second privilege access system (e.g., a configuration that may be incompatible for other privilege access systems).

FIG. 4 illustrates a flowchart containing a series of operations for ML model training (e.g., method 400). The operations illustrated in FIG. 4 may, for example, be performed by, with the assistance of, and/or under the control of an apparatus (e.g., system 130, end-point devices 140, etc.), as described above. In this regard, performance of the operations may invoke one or more of the components described above with reference to FIGS. 1A-1D (e.g., processor 102, processor 152, etc.).

As shown in operation 402, the system 130 may be configured to perform one or more data preparation operations on the operation data from the plurality of disparate privilege access systems. By way of example, the operation data that is received from the plurality of privilege access systems may vary in format, configuration, etc. as described herein. As such, at operation 402, the system 130 may operation to normalize, scale, transform, and/or the like the operation data that is received for triaging the first trained ML model into a suitable form for training. Although described herein with reference to normalization, scaling, and transformation, the present disclosure contemplates that any preprocessing or data preparation operation may be performed by the system at operation 402.

Thereafter, as shown in operations 404 and 406, the system 130 may be configured to generate a plurality of similarly metrics for the operation data and assemble the operation data based on the generated similarly metrics. As described herein, the first trained ML model may be used to model predicted, expected, or otherwise normal behavior (e.g., predicted interactions for users). As such, the system 130 may quantify the similarly between operation data entries at operation 404 by generating a similarly metric for types, groups, etc. of operation data received by the system. Thereafter, the system 130 may, based on the similarity metric, divide the operation data into similar groups or clusters of operation data. The similarly metrics may be based on any number of factors, features, attribute, characteristics, parameters, etc. of the operation data received by the system 130 and/or the intended application of the first trained ML model. By way of continued example, operation data that is indicative of or otherwise associated with permissioning access to particular applications of the system 130 may be group or clustered together.

Thereafter, as shown in operation 408, the system 130 may be configured to perform interrogative analysis on the assembled operation data to model expected activity for the plurality of users. As described herein, the first trained ML model is configured to determine what the normal or expected action, status, response, etc. for a user is given a defined set of characteristics and/or a prediction of the normal or expect action, status, response, etc. for a user interaction. Given that the first trained ML model is trained on operation data from the plurality of disparate privilege access systems the first trained ML model may be configured to determine, when deployed on interaction data for evaluation, if the interaction data is expected, predicted, or otherwise normal. As described herein, the first trained ML model may be iteratively trained to account for a changes in the normal or expected behavior of interaction data that dynamically changes over time.

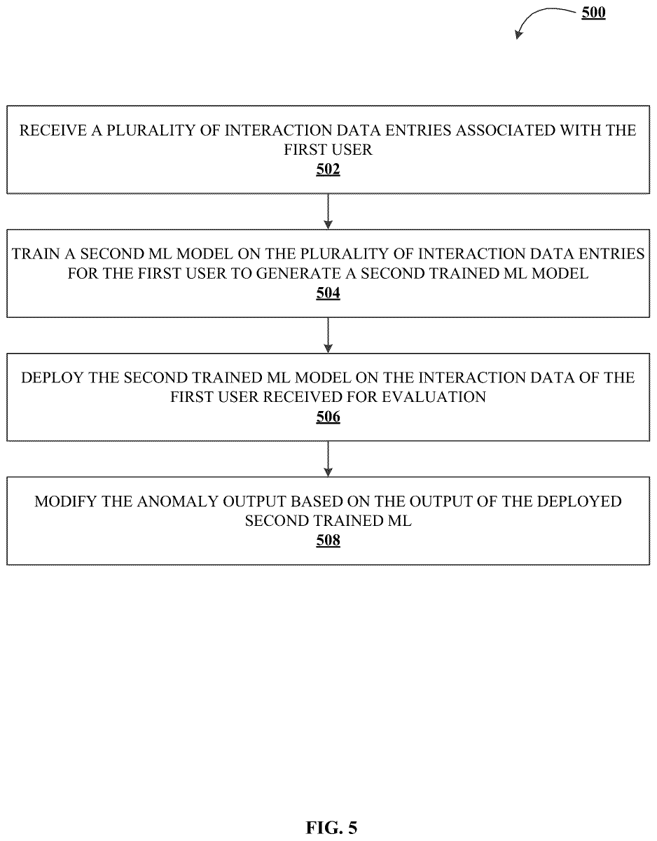

FIG. 5 illustrates a flowchart containing a series of operations for multi-modal post-validation (e.g., method 500). The operations illustrated in FIG. 5 may, for example, be performed by, with the assistance of, and/or under the control of an apparatus (e.g., system 130, end-point devices 140, etc.), as described above. In this regard, performance of the operations may invoke one or more of the components described above with reference to FIGS. 1A-1D (e.g., processor 102, processor 152, etc.).

As shown in operation 502, the system 130 may be configured to receive a plurality of interaction data entries associated with the first user. In the embodiments of FIG. 5, a user-specific ML model (e.g., the second trained ML model) may be trained that operates as a post-validation or modification of the anomaly output of the first trained ML model. In order to model normal activity, interactions, etc. that are associated with the first user, the system 130 may receive a plurality of interaction data entries associated with various interactions of the first user.

As shown in operation 504, the system 130 may be configured to train a second ML model on the plurality of interaction data entries for the first user to generate a second trained ML model. Similar to the training of the first ML model above at operation 204, the second trained ML model may refer to a mathematical model generated by machine learning algorithms based on training data (e.g., interaction data of the first user) to make predictions or decisions without being explicitly programmed to do so. The second trained ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The second trained ML model or algorithm may also refer to programs that are configured to self-adjust and perform better as they are exposed to more data. To this end, the second trained ML model or algorithm is also capable of adjusting its own parameters, based on previous performance in making prediction about a dataset, such as interaction data for a user.

The second ML algorithms contemplated, described, and/or used herein (e.g., the trained ML model) may include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The second ML model may also be trained using repeated execution cycles of experimentation, testing, and tuning to modify the performance of the ML algorithm and refine the results in preparation for deployment of those results for consumption or decision making. The first ML model may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data.

As shown in operations 506 and 508, the system 130 may be configured deploy the second trained ML model on the interaction data of the first user received for evaluation and modify the anomaly output based on the output of the deployed second trained ML. By way of continued example, the deployment of the first trained ML model on the interaction data of the first use for evaluation may determine an anomaly if the interaction data is indicative of acceptable differences between the interaction data for evaluation and the expected or predicted interaction data based on the trained first ML model. In some embodiments, however, the interaction data of the first user may be similar to the expected or predicted interaction for that user (e.g., a user-specific determination). In such an embodiment, the system 130 may modify the anomaly output to account for the output of the second trained ML model. For example, access that was previously precluded for the first user based on the determined anomaly may be provided.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that may direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments may be configured without departing from the scope and spirit of the disclosure. Therefore, it is to be understood that, within the scope of the appended claims, the disclosure may be practiced other than as specifically described herein.

1. A system for dynamic privilege access aggregation and anomaly detection in a distributed network system, the system comprising:
at least one non-transitory storage device; and
at least one processor coupled to the at least one non-transitory storage device, wherein the at least one processor is configured to:
receive operation data from a plurality of disparate privilege access systems, wherein the plurality of disparate privilege access systems are associated with a plurality of users and comprise at least a first privilege access system and a second privilege access system;
train a first machine learning (ML) model on the operation data of the plurality of disparate privilege access systems to generate a first trained ML model;
receive interaction data associated with a first user for evaluation;
deploy the first trained ML model on the interaction data of the first user;
determine an anomaly for the interaction data of the first user based on the output of the deployed first trained ML on the interaction data; and
generate an anomaly output comprising the determined anomaly for the interaction data of the first user.

2. The system of claim 1, wherein the processor is further configured to:
supply the anomaly output to the first trained ML model; and
update the first trained ML based on the anomaly output.

3. The system of claim 1, wherein the first user is absent from the plurality of users associated with the plurality of disparate privilege access systems.

4. The system of claim 1, wherein the plurality of users associated with the plurality of disparate privilege access systems comprise the first user.

5. The system of claim 1, wherein the processor is further configured to:
supply the anomaly output to the first privilege access system in a first data configuration; and
supply the anomaly output to the second privilege access system in a second data configuration different from the first data configuration.

6. The system of claim 1, wherein the anomaly output is configured to preclude access of the first user to at least one of the disparate privilege access systems.

7. The system of claim 1, wherein the first privilege access system is isolated from the second privilege access system.

8. The system of claim 1, wherein, in training the first ML model, the processor is further configured to:
perform one or more data preparation operations on the operation data from the plurality of disparate privilege access systems;
generate a plurality of similarly metrics for the operation data;
assemble the operation data based on the generated similarly metrics; and
perform interrogative analysis on the assembled operation data to model expected activity for the plurality of users.

9. The system of claim 1, wherein the processor is further configured to:
receive a plurality of interaction data entries associated with the first user; and
train a second ML model on the plurality of interaction data entries for the first user to generate a second trained ML model.

10. The system of claim 9, wherein the processor is further configured to:
deploy the second trained ML model on the interaction data of the first user received for evaluation; and
modify the anomaly output based on the output of the deployed second trained ML.

11. A computer program product for dynamic privilege access aggregation and anomaly detection in a distributed network system, the computer program product comprising a non-transitory computer-readable medium comprising code that, when executed, causes an apparatus to:
receive operation data from a plurality of disparate privilege access systems, wherein the plurality of disparate privilege access systems are associated with a plurality of users and comprise at least a first privilege access system and a second privilege access system;
train a first machine learning (ML) model on the operation data of the plurality of disparate privilege access systems to generate a first trained ML model;
receive interaction data associated with a first user for evaluation;
deploy the first trained ML model on the interaction data of the first user;
determine an anomaly for the interaction data of the first user based on the output of the deployed first trained ML on the interaction data; and
generate an anomaly output comprising the determined anomaly for the interaction data of the first user.

12. The computer program product of claim 11, further comprising code that, when executed, causes the apparatus to:
supply the anomaly output to the first privilege access system in a first data configuration; and
supply the anomaly output to the second privilege access system in a second data configuration different from the first data configuration.

13. The computer program product of claim 11, wherein the anomaly output is configured to preclude access of the first user to at least one of the disparate privilege access systems.

14. The computer program product of claim 11, wherein the first privilege access system is isolated from the second privilege access system.

15. The computer program product of claim 11, further comprising code that, when executed, causes the apparatus to:
receive a plurality of interaction data entries associated with the first user;
train a second ML model on the plurality of interaction data entries for the first user to generate a second trained ML model;
deploy the second trained ML model on the interaction data of the first user received for evaluation; and
modify the anomaly output based on the output of the deployed second trained ML.

16. A method for dynamic privilege access aggregation and anomaly detection in a distributed network system, the method comprising:
receiving operation data from a plurality of disparate privilege access systems, wherein the plurality of disparate privilege access systems are associated with a plurality of users and comprise at least a first privilege access system and a second privilege access system;
training a first machine learning (ML) model on the operation data of the plurality of disparate privilege access systems to generate a first trained ML model;
receiving interaction data associated with a first user for evaluation;
deploying the first trained ML model on the interaction data of the first user;
determining an anomaly for the interaction data of the first user based on the output of the deployed first trained ML on the interaction data; and
generating an anomaly output comprising the determined anomaly for the interaction data of the first user.

17. The method of claim 16, further comprising:
supplying the anomaly output to the first privilege access system in a first data configuration; and
supplying the anomaly output to the second privilege access system in a second data configuration different from the first data configuration.

18. The method of claim 16, wherein the anomaly output is configured to preclude access of the first user to at least one of the disparate privilege access systems.

19. The method of claim 16, wherein the first privilege access system is isolated from the second privilege access system.

20. The method of claim 16, further comprising:
receiving a plurality of interaction data entries associated with the first user;
training a second ML model on the plurality of interaction data entries for the first user to generate a second trained ML model;
deploying the second trained ML model on the interaction data of the first user received for evaluation; and
modifying the anomaly output based on the output of the deployed second trained ML.
